(19) United States
(12) Patent Application Publication
(10) Pub. No.: US 2026/0001089 A1
(43) Pub. Date: Jan. 1, 2026

(54) Stainless Steel Spray Boom for Aerial Spraying

(71) Applicant: Texas Transland LLC, Wichita Falls, TX (US)

(72) Inventor: Calvin L. Kroes, Loveland, OK (US)

(21) Appl. No.: 19/320,686

(22) Filed: Sep. 5, 2025

Related U.S. Application Data
(63) Continuation of application No. 17/234,950, filed on Apr. 20, 2021, now Pat. No. 12,415,192.

(51) Int. Cl. B05B 1/20; A01M 7/00; B05B 13/00; B21K 21/04; B64D 1/18

(52) U.S. Cl. CPC B05B 1/20; A01M 7/0071; B05B 13/005; B21K 21/04; B64D 1/18

(57) ABSTRACT

The present disclosure is directed to spray boom for aerial spraying comprising an elongate housing operable to be mounted to an underside of an aircraft, the elongate housing defining a hollow cavity, and a plurality of couplings positioned along at least a portion of a length of the elongate housing, wherein each of the plurality of couplings comprises a cylindrical boss that is unitary with and thermally formed from the elongate housing.

### TECHNICAL FIELD

The present disclosure generally relates to spray booms, and particularly to stainless steel spray booms for aerial spraying by an aircraft.

### BACKGROUND

Aerial spraying is often used as a means of applying pesticides, fungicides, herbicides, fertilizers, and other agents to crops in the agriculture, horticulture, and/or forestry industries. Aerial spraying is typically performed by attaching a liquid reservoir to an aircraft, wherein the liquid reservoir is in fluid communication with a plurality of spray nozzles held in place by one or more spray booms attached to the aircraft.

### BRIEF DESCRIPTION OF THE DRAWINGS

FIG. 1A illustrates a system for aerial spraying from an aircraft, in accordance with certain embodiments;

FIG. 1B illustrates an enlarged view of the system for aerial spraying from an aircraft, in accordance with certain embodiments;

FIG. 2A illustrates a perspective view of a spray boom for aerial spraying, in accordance with certain embodiments;

FIG. 2B illustrates a cross-sectional view of a spray boom for aerial spraying, in accordance with certain embodiments; and

FIG. 3 illustrates a flow diagram of a method for forming a spray boom for aerial spraying, in accordance with certain embodiments.

### DESCRIPTION OF EXAMPLE EMBODIMENTS

### Overview

According to an embodiment, a spray boom for aerial spraying may include an elongate housing operable to be mounted to an underside of an aircraft, the elongate housing defining a hollow cavity, and a plurality of couplings positioned along at least a portion of a length of the elongate housing, wherein each of the plurality of couplings comprises a cylindrical boss that is unitary with and thermally formed from the elongate housing.

Moreover, the elongate housing may comprise a stainless steel composition and may comprise a thickness of at least 0.060 inches.

Additionally, the plurality of couplings may be positioned at least 5 inches apart.

Further, the cylindrical boss may include an opening into the hollow cavity of the elongate housing. Moreover, the cylindrical boss may be thermally formed by via a carbide tool. The application of a rotational movement of the carbide tool at a speed of at least 2500 revolutions per minute (RPM) against the elongate housing may generate friction, thereby generating heat at a temperature ranging between 1900° F. and 2100° F.

Also, the cylindrical boss may comprise a boss length of at least 0.30 inches. An interior surface of the cylindrical boss may be threaded for coupling with a spray nozzle.

According to another embodiment, a method for forming a spray boom for aerial spraying may include the steps of heating an elongate housing at a plurality of locations along a length of the elongate housing using a carbide tool, wherein the step of heating softens a composition of the elongate housing at the plurality of locations; redistributing the softened composition to form a cylindrical boss at each of the plurality of locations, wherein the cylindrical boss is unitary with and thermally formed from the elongate housing; and threading the interior of each cylindrical boss to form a coupling.

Technical advantages of certain embodiments of this disclosure may include one or more of the following. The systems and methods described herein may allow for spray booms having couplings for attaching spray nozzles that are thermally formed from the spray boom housing itself, thereby streamlining the manufacturing process to eliminate the steps of forming pilot holes in the spray boom housing, molding individual couplings, and welding the couplings onto the spray boom housing over the pilot holes. Because the couplings are formed as an extension of the spray boom housing, the couplings are less likely to crack and deform under stress.

Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

Chemical agents, such as pesticides, fungicides, herbicides, fertilizers, and the like, are commonly applied to crops, forests, and other vegetation by aerial spraying. The aircraft used in applying the agents to crops are usually small single-engine airplanes or helicopters that are equipped with a reservoir containing the desired agent to be sprayed. The reservoir may be in fluid communication with one or more spray booms, which may be mounted to the underside, exterior surfaces of the wings or fuselage of the aircraft. A spray boom may comprise a hollow housing fitted with a plurality of spray nozzles along its length. These spray nozzles may attach to the spray boom via a plurality of couplings.

In conventional spray boom systems, the couplings may be manually retrofitted to the spray boom housing by, e.g., drilling pilot holes into the boom housing, molding individual coupling pieces, carefully positioning the couplings over the pilot holes, and then welding the couplings onto the boom housing. There are a number of problems with this technique. Not only are the retrofits often aesthetically malformed by virtue of human error, but the welded couplings are also prone to cracking over time due to the stress and pressure of the fluid dispensed from the boom to the spray nozzles.

The present disclosure is directed to a spray boom for aerial spraying, the spray boom including a plurality of couplings that are thermally formed from the spray boom housing. More specifically, the spray boom includes an elongate housing defining a hollow cavity and a plurality of couplings positioned along at least a portion of a length of the elongate housing, wherein each of the plurality of couplings comprises a cylindrical boss that is unitary with and thermally formed from the elongate housing. Although the systems and methods of the present disclosure have particular application to spray booms mounted onto an aircraft for aerial spraying, it will be appreciated that aspects of the invention may have application to ground spraying as well. However, for purposes of illustration, the present disclosure will reference aerial spraying.

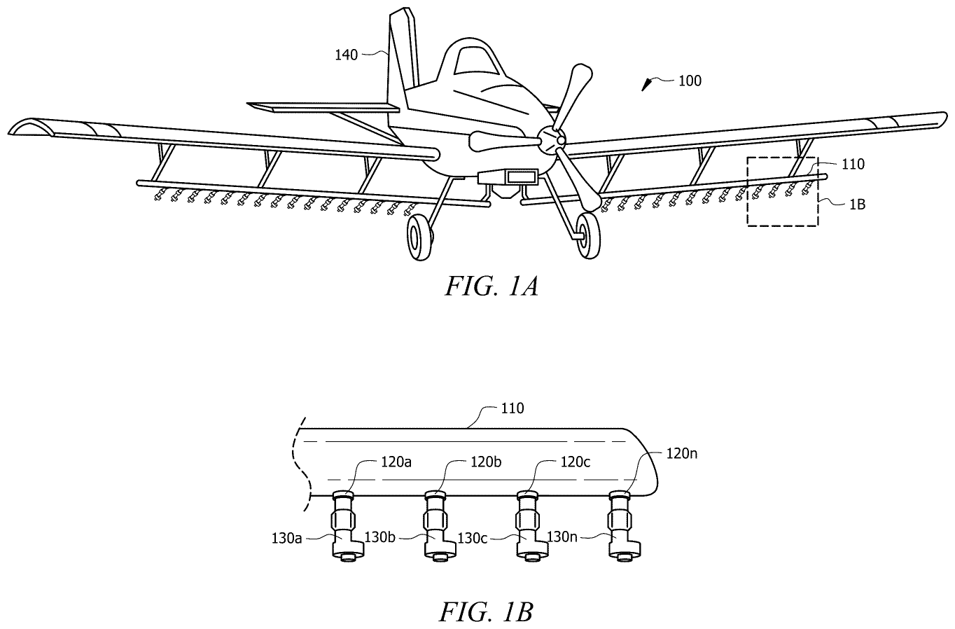

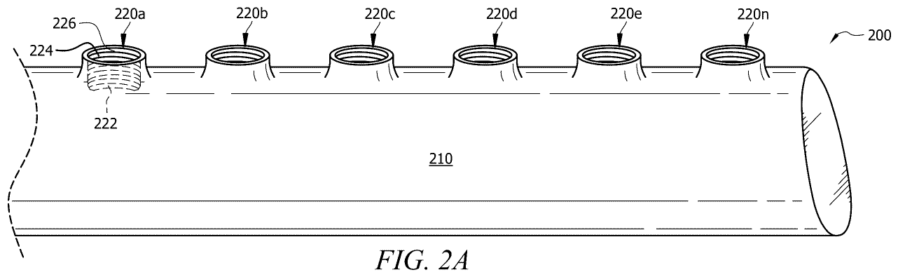

FIGS. 1A and 1B depict a system 100 for aerial spraying from an aircraft 140. The system 100 of FIGS. 1A-1B may include a spray boom 110 mounted to the underside of an aircraft 140. Spray boom 110 may be mounted to the aircraft 140 by various mechanisms known in the art. The spray boom 110 may include a plurality of couplings 120a-n formed from the housing of the spray boom 110. The plurality of couplings 120a-n may be adapted to couple the spray boom 110 to a plurality of spray nozzles 130a-n. The spray boom 110 of the present disclosure is described in more detail below with respect to FIGS. 2A and 2B. While the present disclosure has particular application to aircraft and aerial spraying, it may be appreciated that aspects of the invention may have application to ground spraying as well. However, for illustrative purposes, reference will be made to aerial spraying only.

Reference is now made to FIGS. 2A and 2B, wherein are shown two views of a spray boom 200, in accordance with certain embodiments. FIG. 2A depicts a perspective view of a section of the spray boom 200, and FIG. 2B depicts a cross-sectional view of the spray boom 200. Spray boom 200 may include an elongate housing 210 operable to be mounted to an underside of an aircraft (such as aircraft 140 of FIG. 1). The elongate housing 210 may define an inner hollow cavity 230. In an embodiment, the elongate housing 210 may be generally tubular in structure. The term “tubular” is to be construed broadly in that the cross-sectional shape of the elongate housing 210 may form any shape adapted to be mounted to the underside of an aircraft. For example, FIGS. 2A and 2B depict the elongate housing 210 as generally having a streamline-like cross-section with a substantially ovoid shape. In an embodiment, the elongate housing may comprise a stainless steel material.

The spray boom 200 may further include a plurality of couplings 220a-n spaced apart along at least a portion of the length of the elongate housing 210. In one embodiment, the plurality of couplings may extend along the entire length of the elongate housing 210. In another embodiment, the plurality of couplings 220a-n may extend partially along the length of the elongate housing 210. In an embodiment, the plurality of couplings 220a-n may be spaced along one side of the elongate housing 210. The term “side” may refer to an edge, a surface, a plane, or a line that extends, either wholly or partially, across the length of the elongate housing 210. Although FIG. 2A shows the plurality of couplings 220a-n as comprising six couplings, it is to be understood that the spray boom 200 may be configured with any number of couplings.

Each of the plurality of couplings 220a-n may comprise a cylindrical boss 222 that is unitary with, and thermally formed from, the elongate housing 210. For purposes of simplicity, only one cylindrical boss 222 is labeled in FIGS. 2A and 2B; however, it is to be understood that each coupling of the plurality of couplings 220a-n may comprise a cylindrical boss. The cylindrical boss 222 may include a hole or an opening 224 from the exterior of the elongate housing 210 into the hollow cavity 230 of the elongate housing 210. Moreover, the cylindrical boss 222 may project (or extend) at least partially from the exterior surface of the elongate housing 210, while also at least partially extending into the hollow cavity 230 of the elongate housing 210. Thus, the length of the cylindrical boss 222 may be adapted for attachment to a spray nozzle.

Each cylindrical boss 222 is formed from (or is an extension of) the composition, e.g., stainless steel, that forms the elongate housing 210. In accordance with the present disclosure, a cylindrical boss 222 may be formed from the elongate housing 210 using a carbide tool. In an embodiment, the carbide tool may comprise a tungsten carbide tool. While the disclosure may hereafter refer to the tool as a tungsten carbide tool, it is to be understood that the disclosure is not necessarily limited to a tungsten carbide tool and may comprise any tool operable to thermally form a cylindrical boss, as described herein. The operation of a tungsten carbide tool is generally understood in the art, and may include applying a rotational movement of the tool against a material, here, the stainless steel elongate housing 210, to generate friction, which in turn produces heat. In an embodiment, the tungsten carbide tool may operate at a rotational speed of at least 2500 RPM, and generate heat within a range between 1900° F. and 2100° F. In this range, the stainless steel material of the elongate housing 210 may soften until it becomes malleable.

The softened stainless steel composition of the elongate housing 210 may then be forced by the tungsten carbide tool to flow and redistribute to form a cylindrical shape around the tool. As the tungsten carbide tool is directed further into the softened composition of the elongate housing 210, the cylindrical shape may lengthen and form the cylindrical boss. The resulting cylindrical boss 222 may be five to six times longer than the original thickness of the elongate housing 210. In an embodiment, the thickness of the elongate housing 210 may be at least 0.060 inches, and in some applications may be approximately 0.063 inches, thereby rendering the length of the cylindrical boss (i.e., boss length) to be between 0.30 to 0.38 inches, which may be sufficient for thread engagement with a spray nozzle. Once the composition has cooled, threading 226 may be applied to the interior of the cylindrical boss 222 using a threading tool. The threading 226 may be adapted for coupling with a spray nozzle. While threading 226 is labeled only on one cylindrical boss 222 in FIGS. 2A and 2B, it is to be understood that each cylindrical boss associated with each coupling of the plurality of couplings 220a-n may be threaded.

In an embodiment, as the stainless steel composition of the elongate housing 210 is heated, softened, and redistributed, virtually no material is lost or discarded. Moreover, no additional material is required to be deposited or added onto the elongate housing 210 to create the cylindrical boss 222. In an embodiment, the plurality of couplings 220a-n (each coupling comprising a cylindrical boss 222) may be spaced at least five (5) inches apart. In yet another embodiment, the plurality of couplings may be spaced five (5) to twelve (12) inches apart, or otherwise, as deemed appropriate for particular applications.

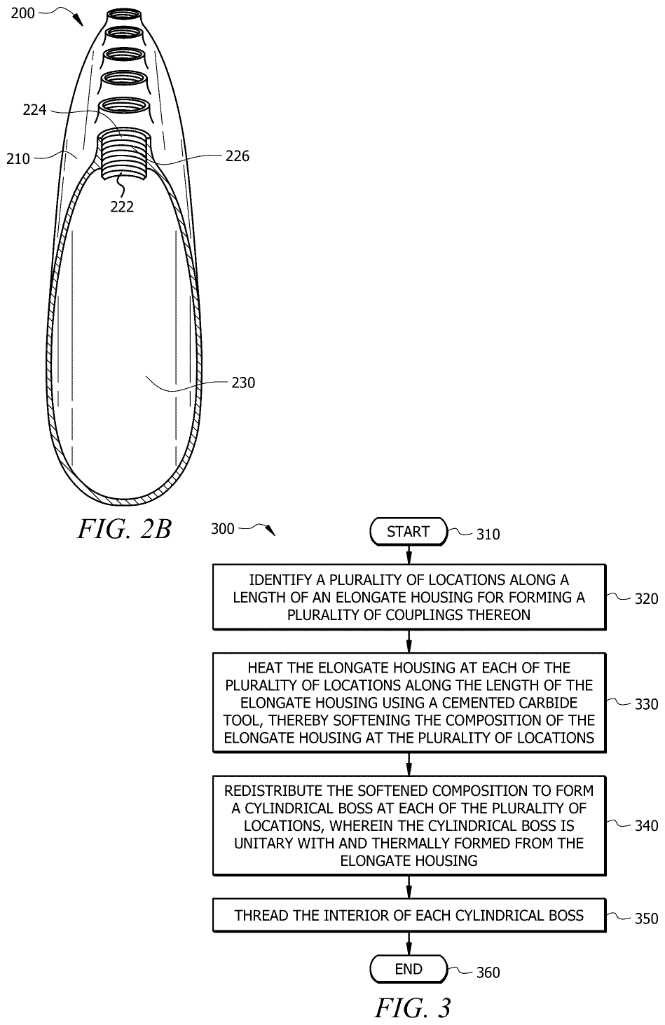

Reference is now made to FIG. 3, wherein is shown a flow diagram of a method 300 for forming a spray boom, according to an embodiment. In an embodiment, the spray boom may be formed from a hollow elongate housing composed of stainless steel. The method may begin at step 310.

At step 320, a plurality of locations along a length of the elongate housing may be identified for forming a plurality of couplings thereon. In one embodiment, the plurality of locations may extend along the entire length of the elongate housing. In another embodiment, the plurality of locations may extend partially along the length of the elongate housing. In an embodiment, the plurality of locations on which to form the plurality of couplings may be spaced along one side of the elongate housing. The term “side” may refer to an edge, a surface, a plane, or a line that extends, either wholly or partially, across the length of the elongate housing. In an embodiment, the plurality of locations on which to form the plurality of couplings may be spaced anywhere between five (5) to twelve (12) inches apart, or otherwise, as deemed appropriate for particular applications.

At step 330, the elongate housing may be heated at each of the plurality of locations along the length of the elongate housing using a carbide tool. In an embodiment, the carbide tool may comprise a tungsten carbide tool, and while the present disclosure may hereafter refer to the tool as such, it is to be understood that the method is not necessarily limited to the use of a tungsten carbide tool, as described above. The step of heating may soften the composition (e.g., stainless steel) of the elongate housing at the plurality of locations. Specifically, in accordance with the operative mechanism of tungsten carbide tools, as generally understood in the art, the application of a rotational movement of the tool against a material (here, the material comprising, e.g., the stainless steel composition of the elongate housing) generates friction, which in turn generates heat. In an embodiment, the tungsten carbide tool may operate at a rotational speed of at least 2500 RPM, thereby generating heat in the range of 1900° F.-2100° F. At this temperature range, the stainless steel composition of the elongate housing may soften until it reaches a malleable plastic-like state. It is to be understood that the step of heating the elongate housing at each of the plurality of locations may be performed sequentially, i.e., location by location for each of the plurality of locations. Alternatively, the step of heating may be performed simultaneously to some degree, i.e., two or more locations heated at the same time.

At step 340, the softened composition may be redistributed to form a cylindrical boss at each of the plurality of locations along the elongate housing, wherein the cylindrical boss is unitary with and thermally formed from the elongate housing. In an embodiment, the tungsten carbide tool may be used to form the softened composition into a cylindrical boss. Specifically, the tungsten carbide tool may force the softened composition to flow and redistribute to form a cylindrical shape around the tool. As the tungsten carbide tool is directed further into the softened composition of the elongate housing, the cylindrical boss may lengthen. The resulting cylindrical boss may be five to six times longer than the original thickness of the elongate housing. In an embodiment, the thickness of the elongate housing may be at least 0.060 inches, and in many applications may be approximately 0.063 inches, thereby rendering the length of the cylindrical boss to be anywhere between 0.30 to 0.38 inches, which may be sufficient for engagement with a spray nozzle. Once the cylindrical boss is formed to the appropriate length, the tungsten carbide tool may be immediately removed.

At step 350, after the composition has cooled to a temperature less than 200° F., the interior of each cylindrical boss may be threaded to form a coupling. The threading of the interiors of all of the cylindrical bosses at the plurality of locations may form the plurality of couplings. The method may end at step 360.

In sum, the systems and methods of the present disclosure may allow for spray booms, such as stainless steel spray booms, having couplings (for coupling the spray booms to spray nozzles, etc.) that are formed from the spray boom itself, thereby eliminating the need for drilling pilot holes into the boom housing, molding separate couplings, and then positioning and welding the couplings onto the boom housing over the pilot holes. The result not only provides for an efficient manufacturing process, but also extends the life of the spray boom and the couplings, as the couplings are unlikely to crack and deform under stress when formed from the spray boom housing.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

The embodiments disclosed herein are only examples, and the scope of this disclosure is not limited to them. Particular embodiments may include all, some, or none of the components, elements, features, functions, operations, or steps of the embodiments disclosed herein. Embodiments according to the disclosure are in particular disclosed in the attached claims directed to a method, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

1-32. (canceled)

33. A spray boom for aerial spraying comprising:
a plurality of couplings positioned along at least a portion of a length of the spray boom, wherein each of the plurality of couplings comprises:
a cylindrical boss thermally formed from the spray boom while at a first temperature; and
a threaded interior surface that is formed while at a second temperature that is less than the first temperature.

34. The spray boom of claim 33, wherein the spray boom comprises a stainless steel composition.

35. The spray boom of claim 33, wherein the spray boom has a metal body, and wherein the metal body has a thickness of at least 0.060 inches.

36. The spray boom of claim 33, wherein the first temperature is greater than the second temperature.

37. The spray boom of claim 33, wherein the cylindrical boss comprises an opening into a hollow cavity of the spray boom.

38. The spray boom of claim 33, wherein the cylindrical boss is thermally formed by a carbide tool.

39. The spray boom of claim 33, wherein application of a rotational movement of a carbide tool at a speed of at least 2500 revolutions per minute (RPM) against the spray boom generates friction, thereby generating heat.

40. The spray boom of claim 33, wherein the first temperature is between 1900° F. and 2100° F.)

41. The spray boom of claim 33, wherein the cylindrical boss comprises a boss length of at least 0.30 inches.

42. The spray boom of claim 33, wherein the second temperature is less than 200° F.

43. A spray boom for aerial spraying comprising:
a material; and
a coupling on the spray boom, wherein the coupling comprises:
a cylindrical boss thermally formed from the material while at a first temperature above 1900° F.; and
a threaded interior surface that is formed while at a second temperature that is less than the first temperature.

44. The spay boom of claim 43, wherein the material is a stainless steel composition.

45. The spay boom of claim 43, wherein the coupling is thermally formed by the application of rotational movement of a tool against the spray boom to generate heat greater than the first temperature.

46. The spay boom of claim 43, wherein the cylindrical boss has a boss length between 0.30 inches and 0.38 inches, and the threaded interior surface extends along the full length of the cylindrical boss.

47. The spay boom of claim 43, wherein:
the cylindrical boss has a boss length between 0.30 inches and 0.38 inches,
the threaded interior surface extends along the full length of the cylindrical boss, and
the threaded interior surface is configured to be coupled with a spray nozzle.

48. The spay boom of claim 43, wherein the cylindrical boss has a boss length at least 5 times longer than a thickness of the material.

49. The spay boom of claim 43, wherein the material is softened when heated to the first temperature.

50. The spay boom of claim 43, wherein the material is softened when heated to the first temperature, and the material is hardened while at the second temperature.

51. The spay boom of claim 43, wherein the material is softened when heated to the first temperature, and the first temperature does not exceed 2100° F.

52. A spray boom for aerial spraying comprising:
a plurality of couplings positioned along at least a portion of a length of the spray boom, wherein each of the plurality of couplings comprises a cylindrical boss that is thermally formed from the spray boom by:
softening a portion of the spray boom by raising a temperature the portion of the spray boom to a first temperature above 1900° F.
